(19) United States
(12) Patent Application Publication
(10) Pub. No.: US 2021/0408963 A1
(43) Pub. Date: Dec. 30, 2021

(54) SYSTEM, METHOD AND DEVICE FOR ROBOTIC CLEANING OF SOLAR PANELS

(71) Applicant: Solar Service Cleaning, LLC, Austin, TX (US)

(72) Inventors: Daniel Dorsch, Shakopee, MN (US); Shane Pratt, Boston, MA (US); Kimberly Jung, Boston, MA (US); Brian Rodriguez, Austin, TX (US)

(73) Assignee: Solar Service Cleaning, LLC, Austin, TX (US)

(21) Appl. No.: 17/354,331

(22) Filed: Jun. 22, 2021

Related U.S. Application Data
(60) Provisional application No. 63/046,201, filed on Jun. 30, 2020.
(60) Provisional application No. 63/171,256, filed on Apr. 6, 2021.

(51) Int. Cl. H02S 40/10; B08B 13/00; B08B 1/00; B08B 1/04; F24S 40/20; B25J 11/00; B25J 9/16; B64D 1/16

(52) U.S. Cl. CPC H02S 40/10; B08B 13/00; B08B 1/002; B08B 1/04; B25J 15/0019; F24S 40/20; B25J 11/0085; B25J 9/162; B64D 1/16; B08B 1/008

(57) ABSTRACT

A robot for cleaning solar panels has a frame and a propulsion system for moving the robot on solar panels. The robot also has arms movably coupled to the frame, and a cleaning assembly coupled to each of the arms for cleaning the solar panels. The arms and cleaning assemblies further facilitate the transportation of the robot between solar panels that are discontinuous and spaced apart from each other. In addition, a water distribution system is included for distributing water during cleaning operations. A control system operates the robot and controls the propulsion system, arms, cleaning assemblies and water distribution system.

### PRIORITY STATEMENT

This application claims priority to and the benefit of U.S. Prov. Pat. App. No. 63/171,256, filed Apr. 6, 2021, and U.S. Prov. Pat. App. No. 63/046,201, filed Jun. 30, 2020, each of which is incorporated herein by reference in its entirety.

### TECHNICAL FIELD

This disclosure generally relates to robots and, in particular, to a system, method and device for robotic cleaning of solar panels.

### BACKGROUND

Global climate change from the dependence on fossil fuels has called our society to turn to energy sources that minimize carbon emissions. Solar power has become one of the preferred sources of renewable energy in the world due to its abundance, dependability, and relatively cheap cost to produce and maintain. Solar panels are installed on residential rooftops, commercial rooftops, car parks and ground-based farms. With exposure to weather over time, solar panels become dirty from caked-on dust and debris. This can lower their operational efficiency by 40% or more, and damage components of the solar panels.

Conventional solar panel cleaning systems typically attach to the frames of panels or attach to fixed rails that are permanently installed at the solar panels site. These systems are either water-based or waterless, and can permanently reside at the site of the solar panels. Although conventional solutions are workable, improvements continue to be of interest.

### SUMMARY

Embodiments of a system, method and apparatus for robotic cleaning of solar panels are disclosed. For example, a robot for cleaning solar panels can have a frame and a propulsion system for moving the robot on solar panels. The robot also can have arms movably coupled to the frame, and a cleaning assembly coupled to each of the arms for cleaning the solar panels. The arms and cleaning assemblies can further facilitate the transportation of the robot between solar panels that are discontinuous and spaced apart from each other. In addition, a water distribution system can be included for distributing water during cleaning operations. A control system can operate the robot and control the propulsion system, arms, cleaning assemblies and water distribution system.

### BRIEF DESCRIPTION OF THE DRAWINGS

FIG. 1 is a top isometric view of an embodiment of a robot.

FIG. 2 is a bottom isometric view of another embodiment of a robot.

FIG. 3 is a top isometric view of an embodiment of a cleaning assembly, with its housing removed.

FIG. 4 is an isometric view of embodiments of a roller assembly and an outrigger for the robot.

FIGS. 5-7 are schematic diagrams of embodiments of a robot in operation while cleaning solar panels.

FIG. 8 is a top isometric view of another embodiment of a robot.

FIG. 9 is a schematic isometric view of an embodiment of a robot with a hose reel.

FIG. 10 is a schematic drawing of an embodiment of an aerial vehicle for hose transport.

FIG. 11 is a schematic drawing of an embodiment of robot transportation system.

FIG. 12 is a schematic diagram of an embodiment of the robot transportation system in operation.

FIG. 13 illustrates a high-level component diagram of an illustrative system architecture according to certain embodiments of this disclosure.

FIG. 14 illustrates a component diagram of a robot according to certain embodiments of this disclosure.

FIG. 15 illustrates example operations of a method for controlling operation of a robot according to certain embodiments of this disclosure.

FIG. 16 illustrates example operations of a method for generating a command instruction based on sensor data according to certain embodiments of this disclosure.

FIG. 17 illustrates example operations of a method for using a control system of a robot to lower the robot from a first solar panel to a second solar panel according to certain embodiments of this disclosure.

FIG. 18 illustrates example operations of a method for using a control system of a robot to raise the robot from a first solar panel to a second solar panel according to certain embodiments of this disclosure.

FIG. 19 illustrates example operations of a method for using a single vehicle to move numerous robots between solar panels according to certain embodiments of this disclosure.

FIG. 20 illustrates an example computer system.

### DETAILED DESCRIPTION

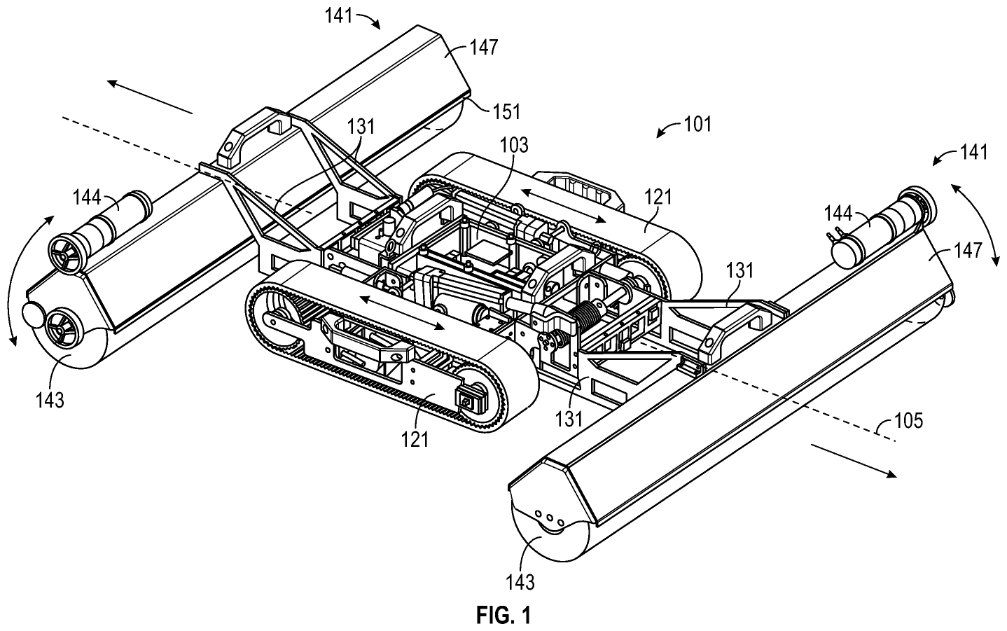

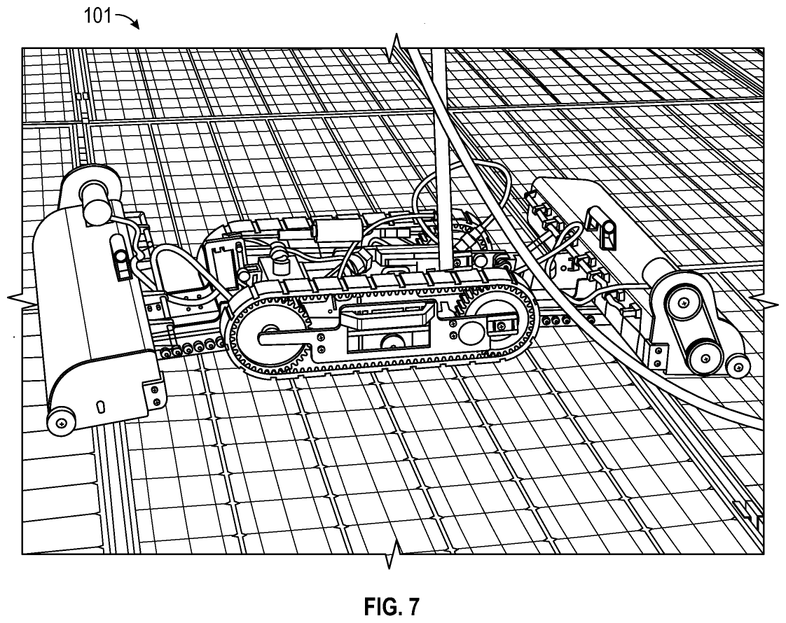

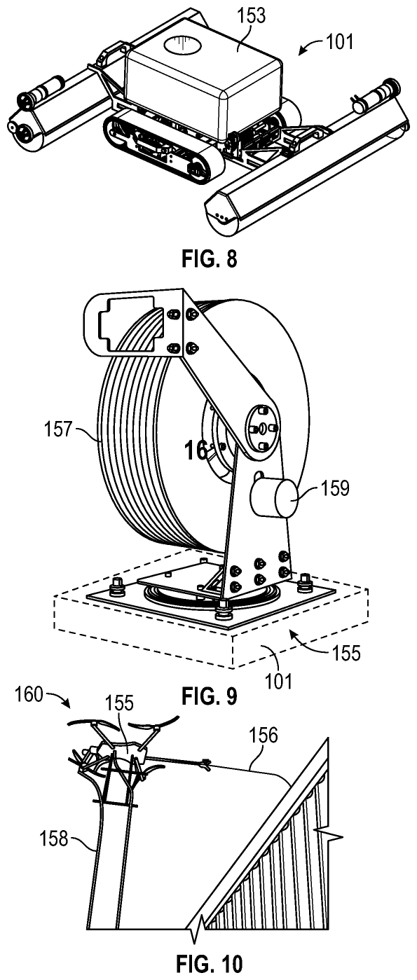

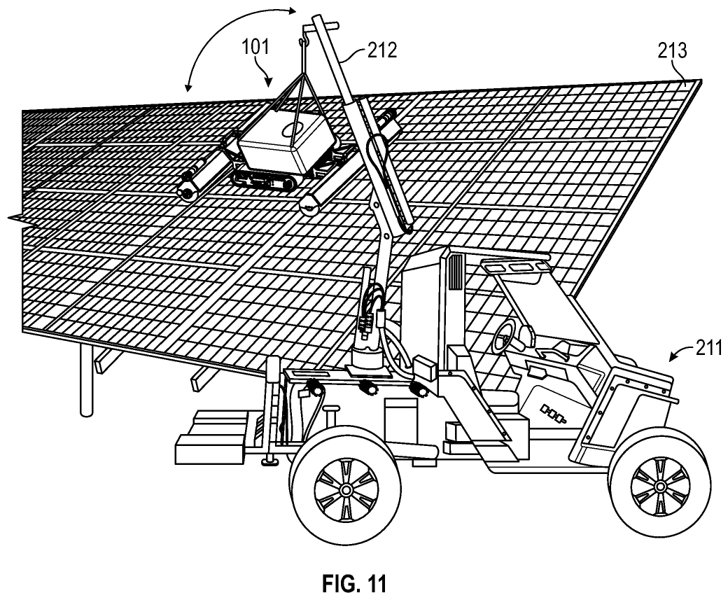

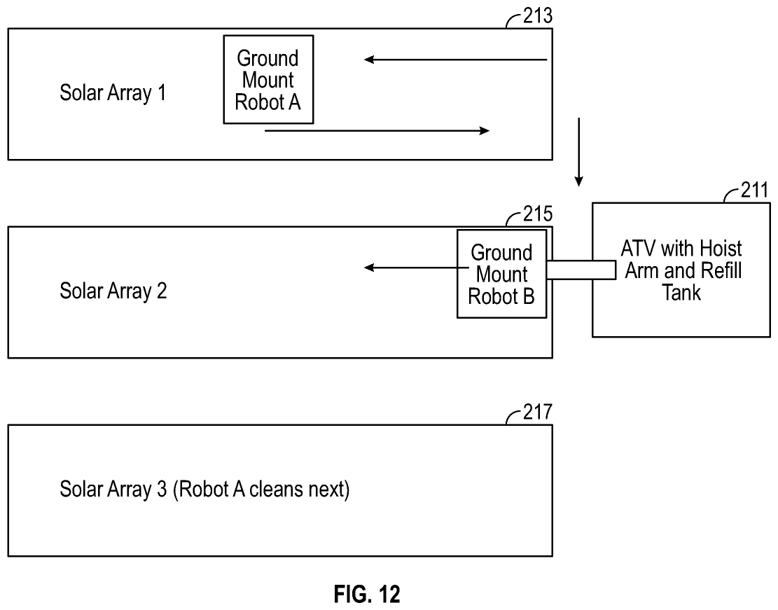

Examples of a system, method and apparatus for a robotic device are disclosed in FIGS. 1-20. Suitable applications for the robot include solar panel cleaning. For example, an actuator can raise and lower a cleaning mechanism that can remove debris with increased friction. Versions can traverse between rows of solar panel arrays quickly and effectively. Embodiments can employ water-based cleaning. Operation and movement can be controlled by a system that can include tracks, hub motors, motor controller and a radio-receiver operated by a human user.

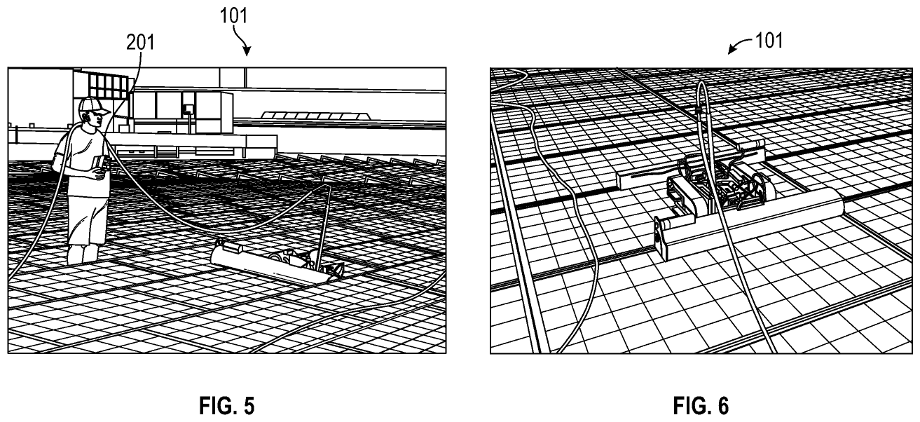

Referring to FIGS. 1-3, embodiments of a robot 101 for cleaning solar panels can include a frame 103 having a longitudinal axis 105. A propulsion system 121 can be coupled to the frame 103 for moving the robot 101 on solar panels. See the examples of FIGS. 5-7. One or more arms 131 can be movably coupled to the frame 103. In the example shown, the robot 101 has four arms 131. A cleaning assembly 141 can be coupled to each of the arms 131 for cleaning the solar panels. The arms 131 and cleaning assemblies 141 also can be configured to facilitate the transportation of the robot 101 between solar panels that are discontinuous and spaced apart from each other. This will be further described in subsequent paragraphs.

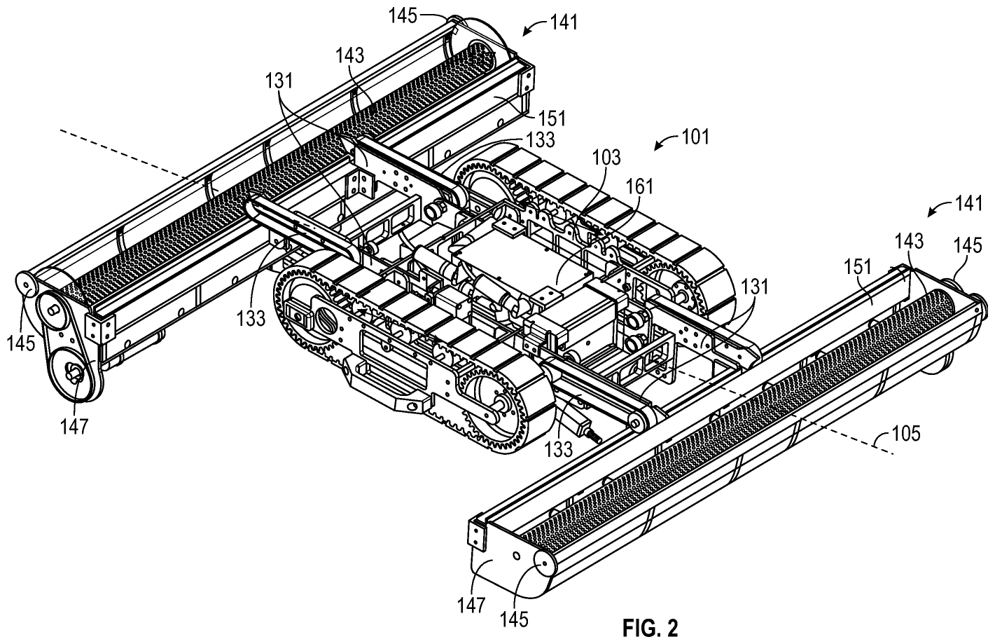

In some embodiments, a water distribution system 151 can be coupled to the robot 101 for distributing water during cleaning operations by the robot 101. A control system 161 (FIG. 2) can be coupled to the frame 103 for operating the robot 101 and controlling the propulsion system 121, arms 131, cleaning assemblies 141 and water distribution system 151.

In some versions, the propulsion system 121 can comprise tracks that are rotatably coupled to opposite sides of the frame 103. In another example, the propulsion system 121 can comprise wheels. The propulsion system 121 also can comprise suction cups. Alternatively, the propulsion system 121 can include a passive suction track system.

Examples of the cleaning assemblies 141 can be located on opposite longitudinal ends of the frame 103. The robot 101 can operate and clean in either longitudinal direction, in some versions.

Embodiments of the robot 101 can further include a user interface 201 (FIG. 5) coupled to the control system 161 for manually operating the robot 101. The user interface 201 can be physically connected to the control system 161. In some versions, however, the user interface 201 is not physically connected to the control system 161 and remote from the robot 101.

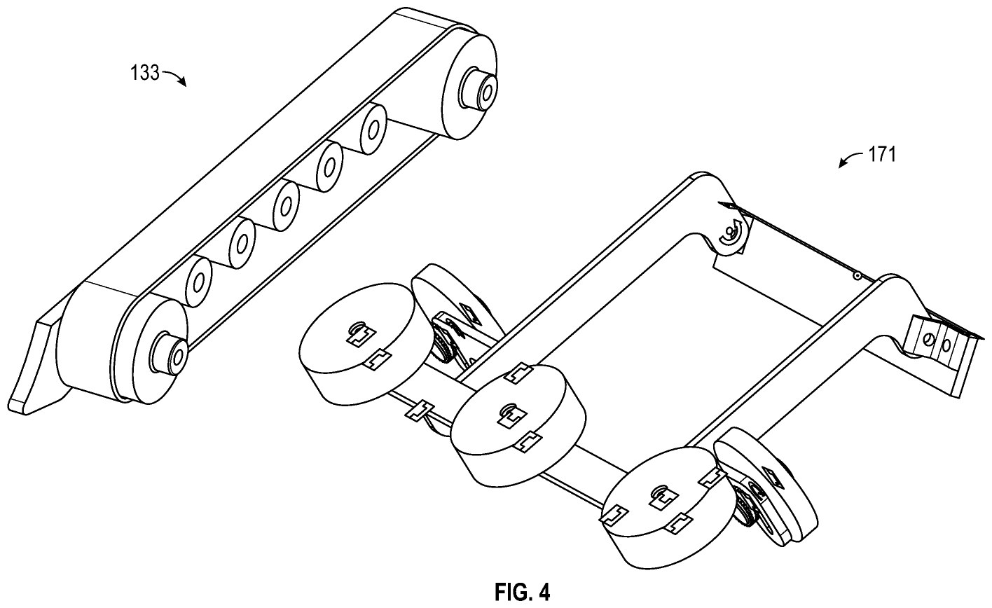

A downward force applied by each of the cleaning assemblies 141 to a solar panel can be adjustable. Each cleaning assembly 141 can include a moveable (e.g., rotatable) brush 143 for cleaning solar panels. The brush 143 can have a selected transverse width that is perpendicular to the longitudinal axis 105. The width can be at least about 39 includes, and up to about 44 inches, in some versions. Other versions can have a width of up to about 84 inches, or even about 96 inches. Each arm 131 can include a slide 133 (FIG. 2) that can be configured to facilitate sliding motion of the robot 101 when traversing between solar panels that are discontinuous and spaced apart from each other. In one example, the slide can be a roller assembly 133 (FIG. 4). One or more outriggers 171 can be mounted to the frame 103 to help guide the robot 101 along linear edges of the solar panel array. Alternatively, the robot 101 can have an electrical or optical system for tracking linear edges of the solar panel array.

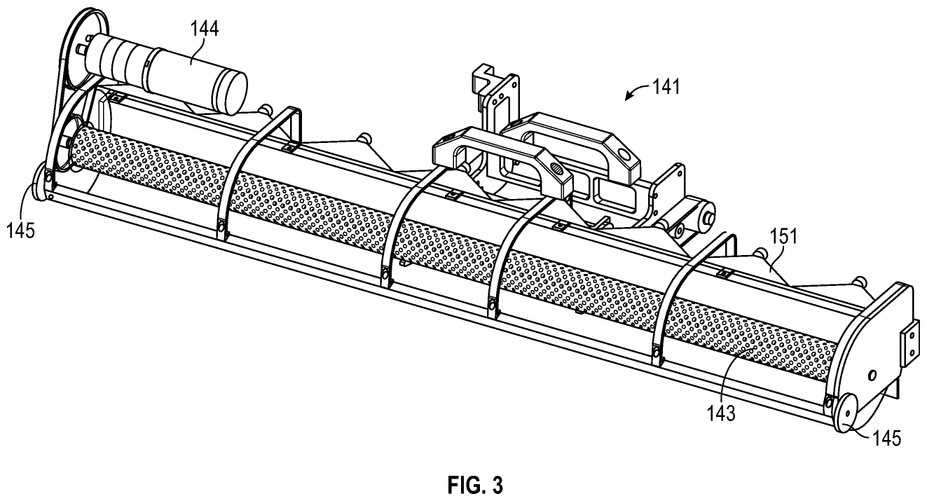

In addition, each cleaning assembly 141 can include one or more distal wheels 145 (FIGS. 2-3) that are rotatable and configured to facilitate movement of the robot 101 when traversing between solar panels that are discontinuous and spaced apart from each other. Each cleaning assembly 141 can be detachable (FIG. 3) from a respective mounting location with respect to the frame 103. Each cleaning assembly 141 can include a motor 144 for rotating the brush 143, and a housing 147 around the brush 143 for containing overspray of water.

Examples of the water distribution system 151 can distribute water, such as via nozzles, into the housing 147 having a rotatable brush 143. The water distribution system 151 can include a water tank 153 mounted to the robot 101. In some versions, the water distribution system 151 can include a hose reel 155 mounted to the robot 101. A hose 157 can be wound on the hose reel 155. The hose 157 can extend to the robot 101 on one end and to a water source on an opposite end, in one example. Moreover, the robot 101 can further include a hose control system 159 for applying force to the hose 157 to supply and retract the hose 157 relative to the robot 101 to avoid slack in the hose 157 while the robot 101 is cleaning the solar panels.

An embodiment of the water distribution system 151 can optionally include an aerial vehicle 160, such as an electric drone. The aerial vehicle 160 can have a supply hose 156 extending to both a water reservoir and the robot 101. The aerial vehicle can be battery-powered, but it also can have an electrical power cord 158 for extended operations. In one embodiment, the hose reel 155 can be mounted to the aerial vehicle 160.

Other embodiments can include various methods of operation for the robot 101. For example, one method can include moving the robot from a first solar panel that is elevated above a second solar panel that is spaced apart from the first solar panel. For example, the solar panels can be spaced apart by up to about 18 inches, either vertically or horizontally.

In this example of the method, a first solar panel is discontinuous and spaced apart from a second solar panel. The robot is located on the first solar panel. Versions of the method can include:

orienting the robot at an edge of the first solar panel and towards the second solar panel;

lowering a first cleaning assembly on a first arm below a top surface of the first solar panel into a space between the first and second solar panels;

raising a second cleaning assembly on a second arm above the frame;

contacting the first cleaning assembly with the second solar panel;

advancing the robot toward the second solar panel;

raising the first cleaning assembly such that the propulsion system contacts the second solar panel while the propulsion system is simultaneously in contact with the first solar panel;

transitioning the propulsion system off of the first solar panel by sliding the robot on roller assemblies on the second arm with the edge of the first solar panel;

moving the robot such that the robot is exclusively on the second solar panel; and then

lowering the first and second cleaning assemblies to contact and clean the second solar panel.

In another example, a method can include moving the robot to a higher panel. Examples of the method can include:

orienting the robot at an edge of the first solar panel and towards the second solar panel;

raising first and second cleaning assemblies above the robot;

advancing the robot toward the second solar panel such that the first cleaning assembly is above the second solar panel;

lowering the first cleaning assembly into contact with the second solar panel;

moving the robot so that the propulsion system transitions into contact with the second solar panel while the propulsion system is simultaneously in contact with the first solar panel;

transitioning the propulsion system off of the first solar panel by supporting some weight of the robot with the second cleaning system on the first solar panel;

moving the robot such that the robot is exclusively on the second solar panel; and then

lowering the first and second cleaning assemblies to contact and clean the second solar panel.

In still another example, a method of cleaning an array of solar panels can include:

providing a plurality of cleaning robots and a single vehicle;

placing a first cleaning robot on a first set of solar panels to clean the first set of solar panels;

placing subsequent cleaning robots on subsequent sets of solar panels to simultaneously clean the respective sets of solar panels;

when the first cleaning robot has cleaned the first set of solar panels, moving the first cleaning robot with the vehicle to another set of solar panels to clean the another set of solar panels;

moving each of the subsequent cleaning robots upon completion of respective cleanings of sets of solar panels.

In some embodiments of the method, of the cleaning robots is autonomous or semi-autonomous. Examples of the vehicle can include an all-terrain vehicle that has an elevation system for lifting and lowering the cleaning robots onto and off of the sets of solar panels. The elevation system can include a hoist or a movable platform, for example.

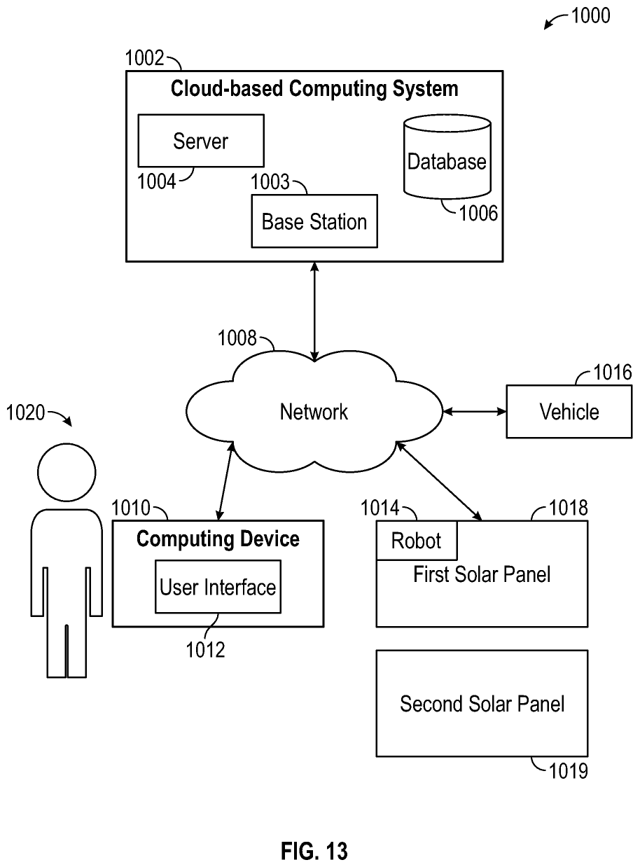

FIG. 13 illustrates a high-level component diagram of an illustrative system architecture 1000 according to certain embodiments of this disclosure. In some embodiments, the system architecture 1000 may include computing device 1010 a cloud-based computing system 1002, a vehicle 1016, a robot 1014, and/or solar panels 1018, 1019 that are communicatively coupled via a network 1008. As used herein, a cloud-based computing system refers, without limitation, to any remote or distal computing system accessed over a network link. In some embodiments, there may be numerous computing devices 1010. The computing devices 1010 may be remote controllers that include input peripherals for sending command instructions to the robot 1014 to control the robot. Each of the computing devices 1010 may include one or more processing devices, memory devices, and network interface devices. The cloud-based computing system 1002 may include one or more servers 1004, one or more base stations 1003, and/or one or more databases 1006. The cloud-based computing system 1002 may be located distally or remotely from the robot 1014.

The network interface devices of any device in FIG. 13 may enable communication via a wireless protocol for transmitting data over short distances, such as Bluetooth, ZigBee, near field communication (NFC), etc. Additionally, the network interface devices may enable communicating data over long distances (e.g., long range (LoRa)), and in one example, the computing devices 1010 may communicate with the network 1008. Network 1008 may be a public network (e.g., connected to the Internet via wired (Ethernet) or wireless (WiFi)), a private network (e.g., a local area network (LAN), wide area network (WAN), virtual private network (VPN)), or a combination thereof.

The computing device 1010 may be any suitable computing device, such as a laptop, tablet, smartphone, or computer. The computing device 1010 may include a display that is capable of presenting a user interface 1012 (e.g., presents control options for driving and/or cleaning via the robot 1014). The computing device 1010 may be operated by a driver and/or robot technician/specialist. The user interface 1012 may be implemented in computer instructions stored on a memory of the computing device 1010 and executed by a processing device of the computing device 1010. The user interface 1012 may be served by as a website by the server 1004. The user interface 1012 may be installed on the computing device 1010 or may be an application (e.g., website) that executes via a web browser.

In some embodiments, the cloud-based computing system 1002 may include one or more servers 1004 that form a distributed, grid, and/or peer-to-peer (P2P) computing architecture. Each of the servers 1004 may include one or more processing devices, memory devices, data storage, and/or network interface devices.

In some embodiments, the cloud-based computing system 1002 may include a database 1006. The database 1006 may store data pertaining to characteristics of the robot 1014, characteristics of the solar panels, characteristics of a geographical region in which the robot and/or the solar panels are located, characteristics of a driver operating the robot 1014, and the like.

In some embodiments, the vehicle 1016 may be an all-terrain vehicle (ATV) that is capable of moving robots 1014 from one set of solar panels to another set of solar panels. The vehicle 1016 may be equipped with a hoist that attaches to a robot 1014 and moves the robot 1014 from one set of solar panels to another. In some embodiments, the vehicle 1016 may be equipped with a platform that moves. The platform may be raised to be substantially level with two sets of solar panels such that a robot 1014 can drive from one solar panel onto the platform and then onto the second set of solar panels. In some embodiments, the user 1020 may use the computing device 1010 (e.g., remote controller) to control the robot 1014 to clean the first solar panel 1018 and the second solar panel 1019.

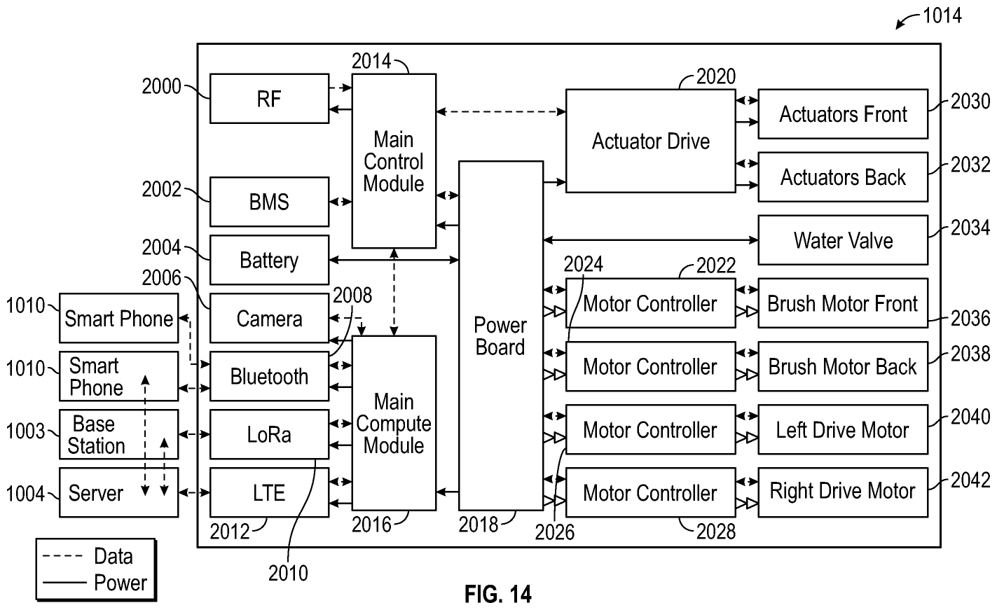

FIG. 14 illustrates a component diagram of a robot 1014 according to certain embodiments of this disclosure. The robot 1014 may include a control system including a main control module 2014, a main compute module 2016, a power board 2018, an actuator drive 2020, motor controllers 2022, 2024, 2026, 2028, etc. Although certain components are depicted, it should be noted that more or less components may be included in the robot 1014 and the description is not limited to the depicted components.

Various devices may communicate with the robot 1014. For example, smart phones 1010 (e.g., computing devices) may communicate via Bluetooth (e.g., network 1008) and send command instructions to the robot's control system. A base station 1003 may communicate with the robot 1014 via a long range (e.g., LoRa network/protocol). In some embodiments, a satellite may be used to communicate data to and from the robot 1014 that cleans solar panels. Further, the server 1004 may communicate with the robot 1014 via the network 1008 using a certain cellular protocol (e.g., a mobile communication standard (LTE)), for example.

The robot 1014 may include a battery 2004 that is rechargeable. In some embodiments, the robot 1014 may include a batter management system 2002 that includes logic to execute to manage the life of the battery 2004. In some embodiments, the robot 1014 may include one or more cameras 2006 configured to capture images or stream real-time video as the robot 1014 cleans a solar panel or drives around a solar panel. Further, the robot 1014 may include one or more network interface devices that are configured to communicate via any suitable wireless and/or wired communication protocol. For example, the robot 1014 may include a Bluetooth 2008 device, a LoRa 2010 device, and/or a LTE 2012 device.

In some embodiments, the robot 1014 may include a main control module 2014 and/or a main compute module 2016. The main control module 2014 and the main compute module 2016 may be included in a control system of the robot 1014. A computing device 1010 may include a radio frequency component 2000 capable of communicating control instructions to the control system of the robot 1014. The main control module 2014 and the main compute module 2016 may be processing devices as described herein. The main control module 2014 may execute command instructions to control the operation of the other components of the robot 1014. For example, the main control module 2014 may cause the robot 1014 to drive at a certain speed and in a certain direction; the main control module 2014 may cause the front and/or rear mechanisms including the cleaning assemblies (e.g., brush motor front 2036, brush motor back 2038) to activate, etc.

The main compute module 2016 may be used to train machine learning models that perform any of the operations disclosed herein. The power board 2018 may be connected via a bus to each electronic component depicted in the robot 1014. The power board 2018 may supply power to an actuator drive 2020 that is connected to front actuators 2030 and back actuators 2032. The front and back actuators 2030 and 2032 may be used to extend and/or retract electromechanical arms to enable cleaning solar panels and/or traversing between solar panels, among other things. In some embodiments, “electromechanical” may refer to a mechanical device that is electrically operated, such as by a solenoid, for example. The power board 2018 may also provide power to the water valve 2034 to enable the water distribution system to disburse water to help clean the solar panels.

Further, the power board 2018 may provide power to motor controllers 2022, 2024, 2026, and 2028. The motor controllers may be connected various motors. The motors may include front brush motor 2036, back brush motor 2038, left motor drive 2040, and right motor drive 2042. The motors may activate and drive cleaning assemblies to clean the solar panels. The motors may activate and rive the tracks and/or wheels to drive the robot 1014 around the solar panels in any suitable direction. As depicted, the dashed lines represent data being sent to each component and the solid lines indicate power being supplied to the components.

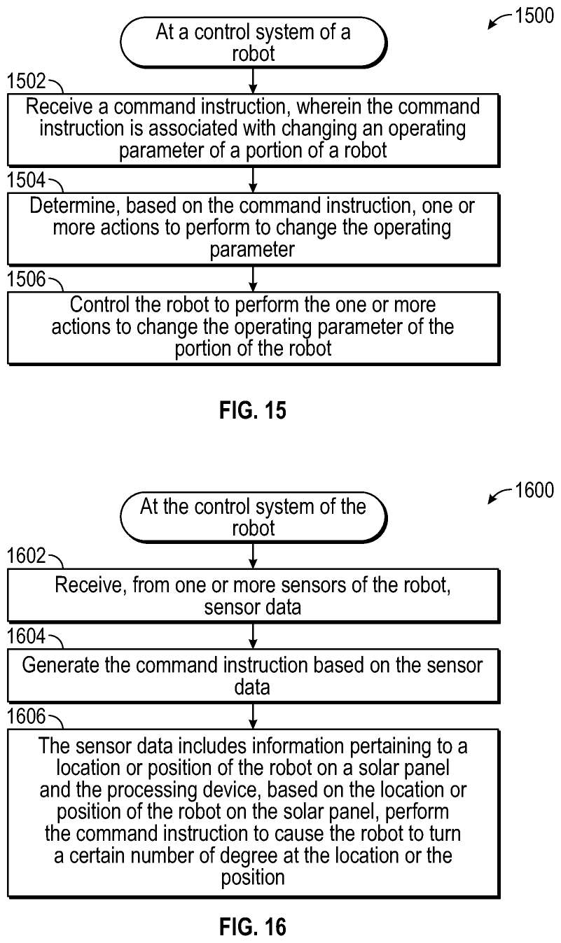

FIG. 15 illustrates example operations of a method 1500 for controlling operation of a robot according to certain embodiments of this disclosure. The method 1500 may be performed by processing logic that may include hardware (circuitry, dedicated logic, etc.), software, or a combination of both. The method 1500 and/or each of their individual functions, subroutines, or operations may be performed by one or more processors of a computing device (e.g., any component (e.g., server 1004, base station 1003 etc.) of cloud-based computing system 1002, the robot 1014 (e.g., main control module 2014, main compute module 2016), or the computing device 1010, of FIG. 13 or FIG. 14) implementing the method 1500. The method 1500 may be implemented as computer instructions stored on a memory device and executable by the one or more processors. In certain implementations, the method 1500 may be performed by a single processing thread. Alternatively, the method 1500 may be performed by two or more processing threads, each thread implementing one or more individual functions, routines, subroutines, or operations of the methods.

At block 1502, the processing device may receive a command instruction. The command instruction may be associated with changing an operating parameter of a portion of the robot 1014. The portion of the robot 1014 may include a propulsion system, a cleaning assembly, a water distribution system, an electromechanical arm, or some combination thereof. The operating parameter may include a revolutions per minute (RPM) of a motor included in the propulsion system and/or the cleaning assembly, activation/deactivation of the cleaning assembly, activation/deactivation of the water distribution system, an actuation (e.g., extension/retraction) of the electromechanical arm, a speed of a motor included in the propulsion system and/or the cleaning assembly, a driving mode (e.g., manual, driver-aided, driver-confirmed, fully autonomous), a driving direction, or the like.

In some embodiments, the command instruction may be received from the computing device 1010 operated by the user 1020 or by a computing device (e.g., server 1004) distally located from the robot 1014. The computing device 101 operated by the user 1020 may be a remote controller that is connected to the control system of the robot 1014 via a wired connection (e.g., Ethernet cable or any suitable data transmission cable) or a wireless connection (e.g., WiFi, Bluetooth, ZigBee, near field communication (NFC), long range (LoRa), etc.). In some embodiments, the processing device may receive the command instruction as a result of input received at a user interface 1012 of the computing device 1010. The user interface 1012 may include one or more virtual graphical elements displayed on a screen and the user may use an input peripheral (e.g., touchscreen, keyboard, mouse, microphone, joystick, etc.) to provide the input. In some embodiments, the user interface 1012 may include one or more joysticks used to control driving direction and/or speed of the robot 1014. The remote controller may enable manual operation of the robot 1014 by the user 1020. The computing device 1010 may include a network interface and/or a transceiver capable of transmitting and/or receiving data (e.g., command instructions).

In some embodiments, the operating parameter may be associated with a saved parameter of a brush included in the cleaning assembly. The saved parameter may be associated with a raised position, an extended position, or a lowered position of the brush. The operating parameter may be associated with a saved parameter of a motor included in the cleaning assembly. The saved parameter may be associated with a revolutions per minute of the motor, a speed of the motor, a rotational direction of the motor, an active or inactive state of the motor, or some combination thereof.

In some embodiments, the operating parameter is associated with a saved parameter of the propulsion system. The saved parameter may be associated with a speed of a motor of the propulsion system, rotational direction of the motor, or some combination thereof.

In some embodiments, the operating parameter is associated with a saved parameter of the water distribution system. The saved parameter may be associated with an active or inactive state of the water distribution system, a flow rate of the water distribution system, an elapsed time of distributing water for the water distribution system, or some combination thereof.

In some embodiments, the operating parameter is associated with a saved parameter of the electromechanical arm(s). The saved parameter may be associated with an actuation state (e.g., extended or retracted) of an actuator that controls the electromechanical arm. The saved parameter may be associated with a raised position, lowered position, extended position, or any suitable position of the electromechanical arm.

It should be noted that one or more saved parameters associated with each of the propulsion system, the cleaning assembly, the water distribution, and/or the electromechanical arm may be used simultaneously in any combination by the control system to operate the robot 1014 according to the operating parameters associated with the saved parameters. The saved parameters may be triggered or selected by the control system of the robot 1014 when certain conditions arise or trigger events occur. For example, the trigger events may be occur when certain sensor data is detected or operating state changes, such as a position or location of the robot 1014 on a solar panel, a status of a cleaning job performed by the robot 1014, a level of battery of the robot 1014, a weather condition, a characteristic of a solar panel (e.g., defect, crack, loose, etc.), a characteristics of the robot 1014 (e.g., temperature of motor, duration of cleaning job, vibration, location, position, etc.), or the like.

In some embodiments, the processing device may receive, from one or more sensors of the robot 1014, sensor data. The processing device may generate the command instruction based on the sensor data. In some embodiments, the command instruction may be generated in real-time (e.g., less than two seconds) or near real-time (e.g., greater than two seconds but less than twenty seconds).

In some embodiments, the sensor data may be associated with a characteristic of the solar panels, a characteristic of the robot 1014, a characteristic of the environment in which the robot 1014 is located, a characteristic of another robot, or some combination thereof. The characteristic of the solar panels may pertain to a level of cleanliness of the solar panels achieved by the robot 1014, a defect (e.g., crack, misalignment, break, etc.), or some combination thereof. The characteristic of the robot 1014 may pertain to a first temperature, a first speed, a first efficiency, a first elapsed time of operation, a first battery level, a first vibration level, a first water volume level, or some combination thereof. The characteristic of the environment in which the robot 1014 is located pertains to a weather condition of the environment. The characteristic of the another robot may pertain to a second temperature, a second speed of its motor, a second efficiency of cleaning the solar panels, a second elapsed time, a second battery level of the another robot, a second vibration level, a second water level of a water tank of the second robot, or some combination thereof.

At block 1504, the processing device may determine, based on the command instruction, one or more actions to perform to change the operating parameter. In some embodiments, sensor data may include information pertaining to a location or positon of the robot on a solar panel. For example, the location or position may be determined based on a proximity sensor that detects and edge of the solar panel. The processing device may, based on the location or position of the robot 1014 on the solar panel, perform a command instruction to cause the robot 1014 to turn a certain number of degrees at the location or the position.

At block 1506, the processing device may control the robot 1014 to perform the one or more actions to change the operating parameter of the portion of the robot 1014. The robot 1014 may be controlled to drive in a certain direction at a certain speed, activate the cleaning assembly and the water distribution system to clean a set of solar panels, stop operation, traverse between discontinuous solar panel arrays, or the like.

In some embodiments, the control system of the robot 1014 may control the robot 1014 in one or more driving modes including manual, driver-aided, driver-confirmed, fully autonomous, or some combination thereof. In some embodiments, manual driving mode may include receiving every command instruction from a computing device operated by a user. In some embodiments, driver-aided driving mode may include generating and executing a first command instruction autonomously while receiving a second command instruction from the computing device of the user. In some embodiments, driver-confirmed driving mode may include generating a third command instruction autonomously and presenting the third command instruction on the computing device of the user, and the user can approve or deny the third command instruction using the computing device. The third instruction may be presented on the robot or computing device as an indicator light or other signal. In some embodiments, fully autonomous driving mode may include the control system or a server generating every command instruction.

In some embodiments, the control system may receive, via a processing device, a selection of a switch associated with a driving direction of the robot 1014. In response to the selection of the switch, the processing device of the control system may change a direction of driving and steering of the robot 1014. The switch may be a physical switch on the computing device 1010 or may be a virtual graphic representation on the user interface 1012 of the computing device 1010. Flipping the switch may cause the robot 1014 to drive in one direction and flipping the switch the switch again may cause the robot 1014 to drive in an opposite direction.

In some embodiments, the processing device may receive sensor data from one or more sensors. The processing device may transmit, via a network 1008 using a network interface device, the sensor data to a remote computing device configured to perform data analytics for asset of robots including at least the robot 1014 based on a set of sensor data including at least the sensor data. The network may include a near field communication network, a local area network, a wide area network, a long range (LoRa) network, or some combination thereof.

In some embodiments, the operating parameter in the command instruction may be associated with the water distribution system and the operating parameter may specify supplying or retracting a hose relative to the robot 1014 to avoid slack in the hose while the robot 1014 is cleaning the solar panels. In some embodiments, the hose may be wound on a reel mounted to the robot 1014.

In some embodiments, the processing device of the control system of the robot 1014, a processing device of the computing device 1010, or a processing device of the server 1004 may control an aerial vehicle. The aerial vehicle may be configured to lift a hose wound on a reel off of a surface of a solar panel as the robot 1014 cleans the solar panel. The aerial vehicle may include a supply hose extending to a water reservoir.

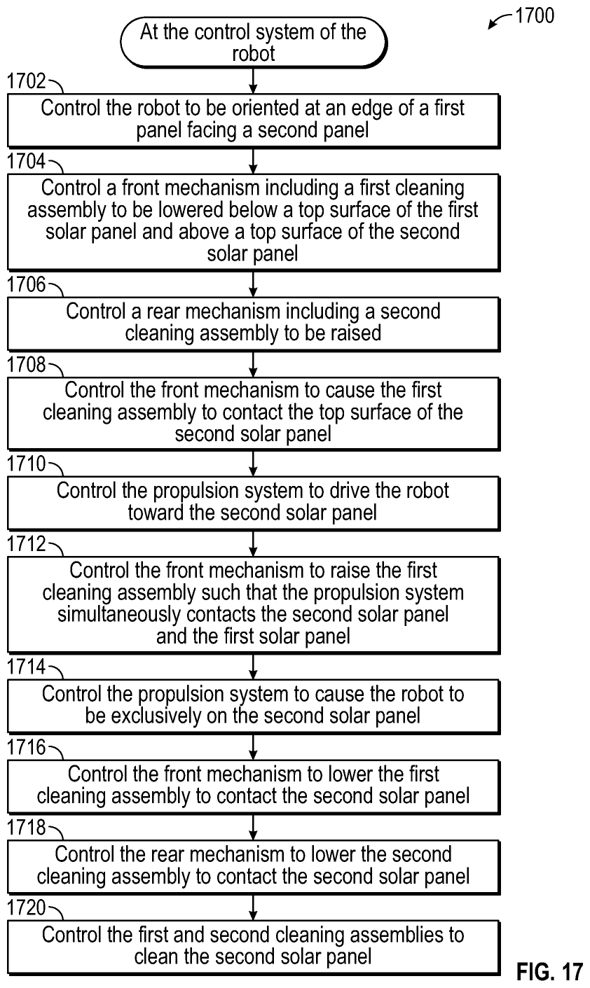

FIG. 16 illustrates example operations of a method 1600 for generating a command instruction based on sensor data according to certain embodiments of this disclosure. The method 1600 may be performed by processing logic that may include hardware (circuitry, dedicated logic, etc.), software, or a combination of both. The method 1600 and/or each of their individual functions, subroutines, or operations may be performed by one or more processors of a computing device (e.g., any component (server 1004, etc.) of cloud-based computing system 1002, the robot 1014 (e.g., main control module 2014, main compute module 2016), or the computing device 1010, of FIG. 13 or FIG. 14) implementing the method 1600. The method 1600 may be implemented as computer instructions stored on a memory device and executable by the one or more processors. In certain implementations, the method 1600 may be performed by a single processing thread. Alternatively, the method 1600 may be performed by two or more processing threads, each thread implementing one or more individual functions, routines, subroutines, or operations of the methods.

In some embodiments, the set of operations of the method 1600 may be performed based on input received from the computing device 1010 (e.g., remote controller) communicatively coupled to the robot 1014.

At block 1602, the processing device may receive, from one or more sensors of the robot 1014, sensor data. The sensors may include any suitable sensor such as a proximity sensor, a camera, an inertial measurement unit (IMU) sensor, a temperature sensor, an accelerometer, a piezoelectric sensor, or some combination thereof. At block 1604, the processing device may generate a command instruction based on the sensor data. At block 1606, the sensor data may include information pertaining to a location or position of the robot 1014 on a solar panel and the processing device may, based on the location or the position of the robot 1014 on the solar panel, perform the command instruction to cause the robot 1014 to turn a certain number of degrees at the location or the position.

FIG. 17 illustrates example operations of a method 1700 for using a control system of a robot to lower the robot from a first solar panel to a second solar panel according to certain embodiments of this disclosure. The method 1700 may be performed by processing logic that may include hardware (circuitry, dedicated logic, etc.), software, or a combination of both. The method 1700 and/or each of their individual functions, subroutines, or operations may be performed by one or more processors of a computing device (e.g., any component (server 1004, etc.) of cloud-based computing system 1002, the robot 1014 (e.g., main control module 2014, main compute module 2016), or the computing device 1010, of FIG. 13 or FIG. 14) implementing the method 1700. The method 1700 may be implemented as computer instructions stored on a memory device and executable by the one or more processors. In certain implementations, the method 1700 may be performed by a single processing thread. Alternatively, the method 1700 may be performed by two or more processing threads, each thread implementing one or more individual functions, routines, subroutines, or operations of the methods.

At block 1702, the processing device may control the robot 1014 to be oriented at an edge of a first solar panel 1018 facing a second solar panel 1019. At block 1704, the processing device may control a front mechanism including a first cleaning assembly to be lowered below a top surface of the first solar panel 1018 and above a top surface of the second solar panel 1019. At block 1706, the processing device may control a rear mechanism including a second cleaning assembly to be raised. At block 1708, the processing device may control the front mechanism to cause the first cleaning assembly to contact the top surface of the second solar panel 1019. At block 1710, the processing device may control the propulsion system to drive the robot 1014 toward the second solar panel 1019. At block 1712, the processing device may control the front mechanism to raise the first cleaning assembly such that the propulsion system simultaneously contacts the second solar panel 1019 and the first solar panel 1018. At block 1714, the processing device may control the propulsion system to cause the robot 1014 to be exclusively on the second solar panel 1019. At block 1716, the processing device may control the front mechanism to lower the first cleaning assembly to contact the second solar panel 1019. At block 1718, the processing device may control the rear mechanism to lower the second cleaning assembly to contact the second solar panel 1019. At block 1720, the processing device may control the first and second cleaning assemblies to clean the second solar panel 1019.

In some embodiments, the set of operations of the method 1700 may be performed based on input received from the computing device 1010 (e.g., remote controller) communicatively coupled to the robot 1014.

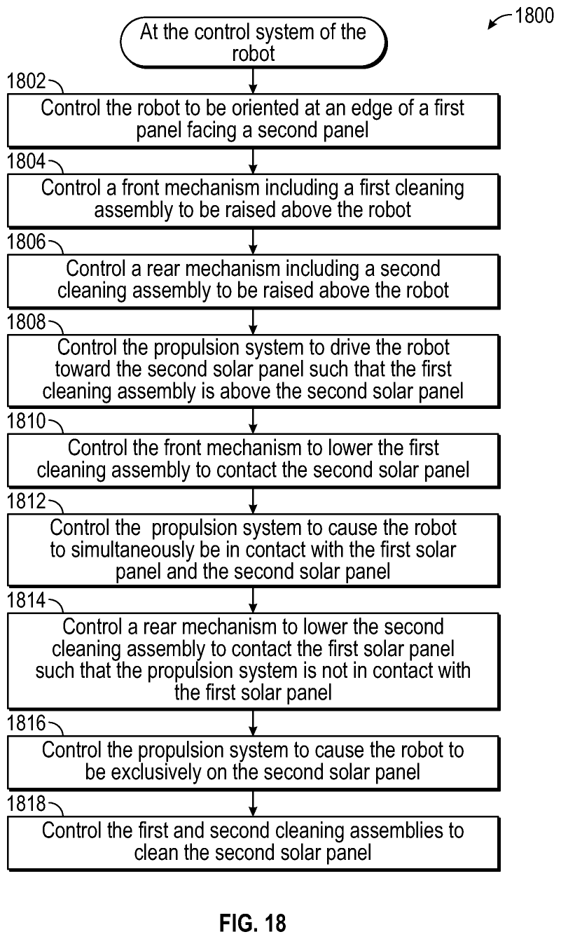

FIG. 18 illustrates example operations of a method 1800 for using a control system of a robot to raise the robot from a first solar panel to a second solar panel according to certain embodiments of this disclosure. The method 1800 may be performed by processing logic that may include hardware (circuitry, dedicated logic, etc.), software, or a combination of both. The method 1800 and/or each of their individual functions, subroutines, or operations may be performed by one or more processors of a computing device (e.g., any component (server 1004, etc.) of cloud-based computing system 1002, the robot 1014 (e.g., main control module 2014, main compute module 2016), or the computing device 1010, of FIG. 13 or FIG. 14) implementing the method 1800. The method 1800 may be implemented as computer instructions stored on a memory device and executable by the one or more processors. In certain implementations, the method 1800 may be performed by a single processing thread. Alternatively, the method 1800 may be performed by two or more processing threads, each thread implementing one or more individual functions, routines, subroutines, or operations of the methods.

At block 1802, the processing device may control the robot 1014 to be oriented at an edge of a first solar panel 1018 facing a second solar panel 1019. At block 1804, the processing device may control a front mechanism including a first cleaning assembly to be raised above a second solar panel 1019. At block 1806, the processing device may control a rear mechanism including a second cleaning assembly to be raised above the robot 1014. At block 1808, the processing device may control the propulsion system to drive the robot 1014 toward the second solar panel 1019 such that the first cleaning assembly is above the second solar panel 1019. At block 1810, the processing device may control the front mechanism to lower the first cleaning assembly to contact the second solar panel 1019. At block 1812, the processing device may control the propulsion system to cause the robot 1014 to simultaneously be in contact with the first solar panel 1018 and the second solar panel 1019. At block 1814, the processing device may control the rear mechanism to lower the second cleaning assembly to contact the first solar panel 1018 such that the propulsion system is not in contact with the first solar panel 1018. At block 1816, the processing device may control the propulsion system to cause the robot 1014 to be exclusively on the second solar panel 1019. At block 1818, the processing device may control the first and second cleaning assemblies to clean the second solar panel 1019.

At block 1710, the processing device may control the propulsion system to drive the robot 1014 toward the second solar panel 1019. At block 1712, the processing device may control the front mechanism to raise the first cleaning assembly such that the propulsion system simultaneously contacts the second solar panel 1019 and the first solar panel 1018. At block 1714, the processing device may control the propulsion system to cause the robot 1014 to be exclusively on the second solar panel 1019. At block 1716, the processing device may control the front mechanism to lower the first cleaning assembly to contact the second solar panel 1019. At block 1718, the processing device may control the rear mechanism to lower the second cleaning assembly to contact the second solar panel 1019. At block 1720, the processing device may control the first and second cleaning assemblies to clean the second solar panel 1019.

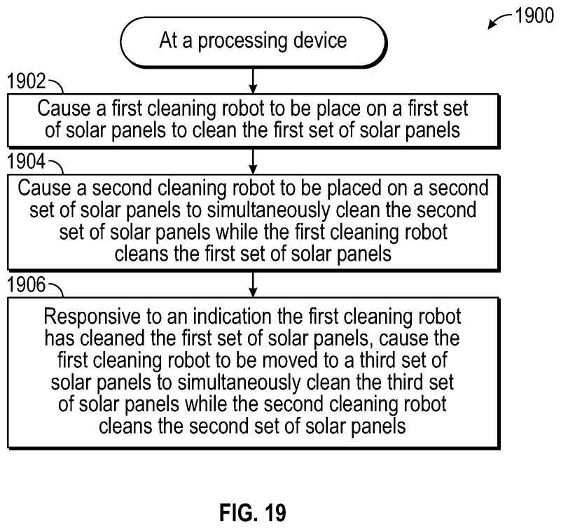

FIG. 19 illustrates example operations of a method 1900 for using a single vehicle to move numerous robots between solar panels according to certain embodiments of this disclosure. The method 1900 may be performed by processing logic that may include hardware (circuitry, dedicated logic, etc.), software, or a combination of both. The method 1900 and/or each of their individual functions, subroutines, or operations may be performed by one or more processors of a computing device (e.g., any component (server 1004, etc.) of cloud-based computing system 1002, the robot 1014 (e.g., main control module 2014, main compute module 2016), or the computing device 1010, of FIG. 13 or FIG. 14) implementing the method 1900. The method 1900 may be implemented as computer instructions stored on a memory device and executable by the one or more processors. In certain implementations, the method 1900 may be performed by a single processing thread. Alternatively, the method 1900 may be performed by two or more processing threads, each thread implementing one or more individual functions, routines, subroutines, or operations of the methods.

It should be noted that, in some embodiments, the processing device may transmit command instructions to cause another computing device (e.g., control system) to perform desired operations.

At block 1902, the processing device may cause a first cleaning robot to be placed on a first set of solar panels to clean the first set of solar panels. At block 1904, the processing device may cause a second cleaning robot to be placed on a second set of solar panels to simultaneously clean the second set of solar panels while the first cleaning robot cleans the first set of solar panels.

At block 1906, responsive to an indication the first cleaning robot has cleaned the first set of solar panels, cause the first set of solar panels, the processing device may cause the first cleaning robot to be moved to a third set of solar panels to simultaneously clean the third set of solar panels while the second cleaning robot cleans the second set of solar panels. In some embodiments, a hoist may be used to move the robots 1014 from panel to panel.

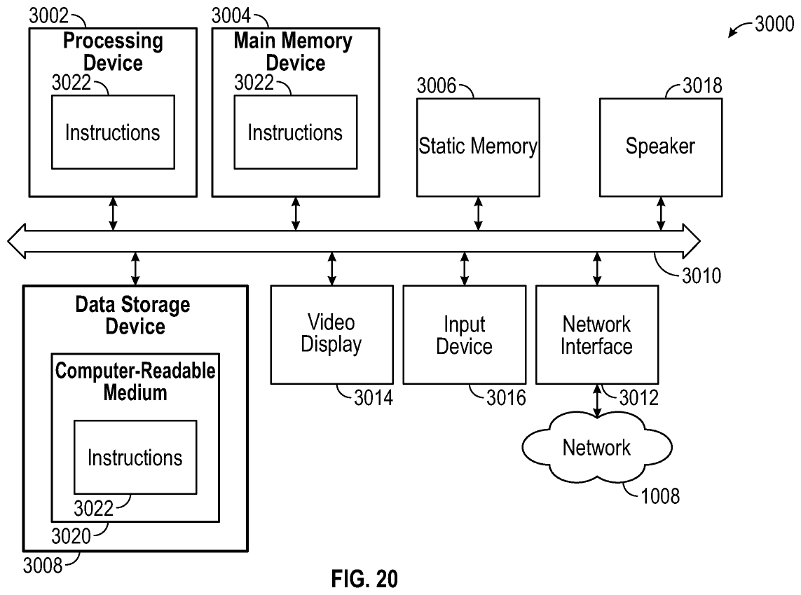

FIG. 20 illustrates an example computer system 3000, which can perform any one or more of the methods described herein. In one example, computer system 3000 may correspond to the computing device 1010, any component of the robot 1014, or the one or more servers 1004 of the cloud-based computing system 1002 of FIG. 13 or FIG. 14. The computer system 3000 may be capable of executing the user interface 1012 (e.g. virtual marketplace platform). The computer system 3000 may be connected (e.g., networked) to other computer systems in a LAN, an intranet, an extranet, or the Internet. The computer system 3000 may operate in the capacity of a server in a client-server network environment. The computer system 3000 may be a personal computer (PC), a tablet computer, a laptop , a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 3000 includes a processing device 3002, a main memory 3004 (e.g., read-only memory (ROM), solid state drive (SSD), flash memory, dynamic random access memory (DRAM) such as synchronous DRAM (SDRAM)), a static memory 3006 (e.g., solid state drive (SSD), flash memory, static random access memory (SRAM)), and a data storage device 3008, which communicate with each other via a bus 3010.

Processing device 3002 represents one or more general-purpose processing devices such as a microprocessor, central processing unit, or the like. More particularly, the processing device 3002 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 3002 may also be one or more special-purpose processing devices such as an application specific integrated circuit (ASIC), a field programmable gate array (FPGA), a digital signal processor (DSP), network processor, or the like. The processing device 3002 is configured to execute instructions for performing any of the operations and steps discussed herein.

The computer system 3000 may further include a network interface device 3012. The computer system 3000 also may include a video display 3014 (e.g., a liquid crystal display (LCD) or a cathode ray tube (CRT)), one or more input devices 3016 (e.g., a keyboard and/or a mouse), and one or more speakers 3018 (e.g., a speaker). In one illustrative example, the video display 3014 and the input device(s) 3016 may be combined into a single component or device (e.g., an LCD touch screen).

The data storage device 3016 may include a computer-readable medium 3020 on which the instructions 3022 (e.g., implementing the user interface 1012, and/or any component depicted in the FIGURES and described herein) embodying any one or more of the methodologies or functions described herein are stored. The instructions 3022 may also reside, completely or at least partially, within the main memory 204 and/or within the processing device 3002 during execution thereof by the computer system 3000. As such, the main memory 3004 and the processing device 3002 also constitute computer-readable media. The instructions 3022 may further be transmitted or received over a network via the network interface device 3012.

While the computer-readable storage medium 3020 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In some embodiments, the robot can include a cleaning fluid dosing system. A dosing tank for cleaning fluid can be mounted to the robot 101. A pump mounted to the robot 101 can be used to pump cleaning fluid through the spray nozzles 151. This cleaning fluid could be sprayed simultaneously to water spray through the same nozzles, coming from any applicable water source such as a tank, faucet, other applicable water distribution system. Alternatively, cleaning fluid could be sprayed through separate nozzles used only for cleaning fluid. In other embodiments, the robot may have a valve to switch between cleaning fluid dosing and water spray, which would be selectively chosen by the operator controller, or the robot control system. Cleaning fluid may be sprayed only for particularly dirty panels, which may be detected by the operator, a robot vision system mounted to the robot, surveying of the site prior or during cleaning to understand panel soiling levels, data on panel or spring production to understand which panels have highest soiling levels, or any other means.

In some embodiments, the robot 101 may have a spring, which is rotationally coupled between the brush arm 131 and the robot frame 103. This spring can be a mechanical spring, leaf spring, coil spring, clock spring, constant force spring, gas spring, or any other relevant form of spring. The spring can be used to modify the downward force between the brush 143 and a solar panel. The spring can apply more pressure than the weight of the brush applies from the force of gravity on the cleaning assembly 141, or can reduce the force so the brush applies less force than resulting force from gravity on the weight of the cleaning assembly 141.

To allow for movable brushes, while maintaining proper cleaning force, intentional compliance may be introduced. With this compliance, motion of the actuator does not exactly define the rotational position of the brush assembly. For instance, the actuator can travel to roughly define the brush position. Once the actuator is moved to a desired position, such as the extended cleaning position, the cleaning assembly can be further lifted or lowered slightly. This lifting and lowering may be caused by a panel, where the actuator moves the cleaning assembly into cleaning position, and the panel causes the brush assembly to lift and lower, maintaining uniform contact pressure with uneven solar panel surfaces.

In some embodiments, compliance is introduced in the motion system between the brush motion actuation system and the brush arm 131. Alternatively, the compliance may be introduced between the brush motion actuation system and the robot frame 103. This compliance may be achieved by a pin-slot configuration, where the pin is mounted to the brush arm 131, and a slot is made in the end of the moving portion of an actuator that lifts and lower the brushes. In an alternative embodiment, a compliant material element such as a stiff spring or compliant material (rubber) or any other applicable material may be mounted to achieve compliance.

In some embodiments of the brush motion compliance system, a mechanical travel limit may be employed. This limit can result in differential amounts of intentional compliance based on the rotational position of the brush arm with respect to the robot frame. One method to achieve adjustable compliance in a pin-slot compliance system is an interface surface on the distal end of the brush arm actuator that can mechanically interfere with an interface surface mounted adjacent to the pin which would be mounted to the brush arm 131. The geometry of the interface surfaces can allow for differential compliance, for example, full compliance in the extended position when cleaning, and reduced compliance in the raised or lowered cleaning assembly position. In some embodiments, the interface surfaces can be located on the throat of the pin mount, and the distal end of the actuator slot. The preferred embodiment is a pin to throat distance that allows for full compliance in the horizontal position, but radius corners of the actuator end adjacent to the slot, that interfere with the throat when the angle between the actuator end surface and the throat surface is substantially different from zero degrees.

In some embodiments, compliance may be added to allow the cleaning assembly 141 to rotate around the longitudinal axis 105 with respect to the propulsion system 121. This compliance allows the brushes to maintain uniform contact, even if there is twist or uneven mounting in a solar panel, or solar panel array. This longitudinal axis compliance may be achieved via features in the frame 103, the brush arms 131, the brush mounting on the brush frame, the mounting of the propulsion system to the frame, via a suspension or similar, or any other applicable location on the robot.

Still other embodiments can include one or more of the following items.

1. A robot for cleaning solar panels, the robot comprising:
a frame having a longitudinal axis;
a propulsion system coupled to the frame for moving the robot on solar panels;
an arm movably coupled to the frame;
a cleaning assembly coupled to the arm for cleaning the solar panels, the arm and cleaning assembly also are configured to facilitate the transportation of the robot between solar panels that are discontinuous and spaced apart from each other;
a water distribution system coupled to the robot for distributing water during cleaning operations; and
a control system coupled to the robot for operating the robot and controlling the propulsion system, arm, cleaning assembly and water distribution system.

2. The robot wherein the propulsion system comprises tracks rotatably coupled to opposite sides of the frame.

3. The robot wherein the propulsion system comprises wheels.

4. The robot wherein the propulsion system comprises suction cups.

5. The robot wherein the propulsion system comprises a passive suction track system.

6. The robot wherein the cleaning assembly comprises two cleaning assemblies that are located on opposite longitudinal ends of the frame.

7. The robot wherein the robot can operate and clean in either longitudinal direction.

8. The robot further comprising a user interface coupled to the control system for manually operating the robot.

9. The robot wherein the user interface is physically connected to the control system.

10. The robot wherein the user interface is not physically connected to the control system and remote from the robot.

11. The robot wherein a downward force applied by the cleaning assembly to a solar panel is adjustable.

12. The robot wherein the cleaning assembly comprises a rotatable brush for cleaning the solar panels.

13a. The robot wherein the arm comprises a slide configured to facilitate sliding motion of the robot when traversing between solar panels that are discontinuous and spaced apart from each other.

13b. The robot wherein the slide comprises a roller assembly.

14. The robot wherein the cleaning assembly comprises distal wheels that are rotatable and configured to facilitate movement of the robot when traversing between solar panels that are discontinuous and spaced apart from each other.

15. The robot wherein the cleaning assembly is detachable from a mounting location with respect to the frame and comprises a motor for rotating a brush and a housing around the brush for containing overspray of water.

16. The robot wherein the water distribution system distributes water via nozzles into a cleaning housing having a rotatable brush.

17. The robot wherein the water distribution system comprises a water tank mounted to the robot.

18. The robot wherein the water distribution system comprises a reel mounted to the robot, a hose wound on the reel that extends to the robot on one end and to a water source on an opposite end.

19. The robot further comprising a hose control system for applying force to the hose to supply and retract the hose relative to the robot to avoid slack in the hose while the robot is cleaning the solar panels.

20. The robot wherein the water distribution system comprises an aerial vehicle.

21. The robot where the aerial vehicle comprises a supply hose extending to both a water source and the robot.

The robot can move to a lower panel.

22. The robot wherein a first solar panel is discontinuous and spaced apart from a second solar panel, and the robot is located on the first solar panel, and further comprising a method of:
orienting the robot at an edge of the first solar panel and towards the second solar panel;
lowering a first cleaning assembly on the arm below a top surface of the first solar panel into a space between the first and second solar panels;
raising a second cleaning assembly on a second arm above the frame;
contacting the cleaning assembly with the second solar panel;
advancing the robot toward the second solar panel;
raising the cleaning assembly such that the propulsion system contacts the second solar panel while the propulsion system is simultaneously in contact with the first solar panel;
transitioning the propulsion system off of the first solar panel by sliding the robot on a slide on the second arm with the edge of the first solar panel;
moving the robot such that the robot is exclusively on the second solar panel; and then
lowering the cleaning assembly and the second cleaning assembly to contact and clean the second solar panel.

These steps can be done in different orders. For example, the previous contacting and advancing steps can be reversed. The cleaning assembly could be moved some of the way, but not all of the way into contact with the second solar panel. Thereafter, the robot could be advanced to complete the contact.

In another example, the robot can move to a lower panel without first lowering the front brush down. Some versions can move to a lower panel with the back brush horizontal, not up. Others can do so with the front brush down and the back brush up.

Embodiments of the method can include raising the front brush and the rear brush at the same time, thereby lowering the robot all at once.

Another embodiment can include lowering the front brush and keeping the rear brush up while transitioning the robot.

Still another embodiment can include raising both the front and rear brushes up for smaller gaps, since the front brush is not needed for a quick transition to another panel.

Yet another embodiment positions the front brush down with the rear brush horizontal. This version can be used on the largest of gaps between panels, or less common circumstances.

Another example has the front brush up and the rear brush in a horizontal position.

The robot can move to a higher panel.

23. The robot further comprising a method of:
orienting the robot at the edge of the first solar panel and towards the second solar panel;
raising the cleaning assembly and the second cleaning assembly above the robot;
advancing the robot toward the second solar panel such that the cleaning assembly is above the second solar panel;
lowering the cleaning assembly into contact with the second solar panel;
moving the robot so that the propulsion system transitions into contact with the second solar panel while the propulsion system is simultaneously in contact with the first solar panel;
transitioning the propulsion system off of the first solar panel by supporting some weight of the robot with the second cleaning system on the first solar panel;
moving the robot such that the robot is exclusively on the second solar panel; and then
lowering the cleaning assembly and the second cleaning assembly to contact and clean the second solar panel.

24. A method of cleaning an array of solar panels, the method comprising:
providing a plurality of cleaning robots and a single vehicle;
placing a first cleaning robot on a first set of solar panels to clean the first set of solar panels;
placing subsequent cleaning robots on subsequent sets of solar panels to simultaneously clean the respective sets of solar panels;
when the first cleaning robot has cleaned the first set of solar panels, moving the first cleaning robot with the vehicle to another set of solar panels to clean the another set of solar panels;
moving each of the subsequent cleaning robots upon completion of respective cleanings of sets of solar panels.

25. The method wherein each of the cleaning robots is autonomous or semi-autonomous.

26. The method wherein the vehicle is an all-terrain vehicle comprises a transport system for placing the cleaning robots onto and off of the sets of solar panels.

27. The method wherein the elevation system comprises a hoist, a fixed platform or a movable platform.

28. A computer-implemented method for using a control system of a robot to control the robot to clean solar panels, wherein the method comprises:

receiving, at a processing device of the control system, a command instruction, wherein the command instruction is associated with changing an operating parameter of a portion of the robot, wherein the portion comprises a propulsion system, a cleaning assembly, a water distribution system, an electromechanical arm, or some combination thereof;

determining, based on the command instruction, one or more actions to perform to change the operating parameter; and

controlling, via the processing device, the robot to perform the one or more actions to change the operating parameter of the portion of the robot.

29. The computer-implemented method wherein the operating parameter is associated with a saved parameter of a brush included in the cleaning assembly.

30. The computer-implemented method wherein the saved parameter is associated with a raised position, an extended cleaning position, ora lowered position of the brush.

31. The computer-implemented method wherein the operating parameter is associated with a saved parameter of the propulsion system.

32. The computer-implemented method wherein the saved parameter is associated with a speed of a motor of the propulsion system, a rotational direction of the motor, or some combination thereof.

33. The computer-implemented method wherein the command instruction is received from a computing device operated by a user or a computing device distally located from the robot.

34. The computer-implemented method further comprising receiving the command instruction as a result of input received at a user interface of a computing device communicatively connected to the robot.

35. The computer-implemented method wherein the computing device comprises a remote controller configured to enable manual operation of the robot.

36. The computer-implemented method wherein the computing device is connected via a wire to the control system.

37. The computer-implemented method further comprising:

receiving, from one or more sensors of the robot, sensor data; and

generating the command instruction based on the sensor data.

38. The computer-implemented method further comprising generating, by the processing device, the command instruction in real-time or near real-time.

39. The computer-implemented method wherein the sensor data is associated with a characteristic of the solar panels, a characteristic of the robot, a characteristic of an environment in which the robot is located, a characteristic of another robot, or some combination thereof.

40. The computer-implemented method wherein:

the characteristic of the solar panels pertains to a level of cleanliness of the solar panels achieved by the robot, a temperature of the solar panels, a defect of the solar panels, or some combination thereof,

the characteristic of the robot pertains to a first temperature, a first speed, a first efficiency, a first elapsed time of operation, a first battery level, a first vibration, a first water level, or some combination thereof,

the characteristic of the environment in which the robot is located pertains to a weather condition of the environment,

the characteristic of the another robot pertains to a second temperature, a second speed, a second efficiency, a second elapsed time of operation, a second battery level, a second vibration, a second water level, or some combination thereof.

41. The computer-implemented method wherein the sensor data comprises information pertaining to a location or position of the robot on a solar panel, and the method further comprises:
based on the location or position of the robot on the solar panel, performing the command instruction to cause the robot to turn a certain number of degrees at the location or the position, or to move the cleaning assembly to a desired position.

42. The computer-implemented method further comprising performing, by the processing device, a set of operations comprising:

controlling the robot to be oriented at an edge of a first panel facing a second panel, wherein the second panel is discontinuous and separate from the first panel;

controlling a front mechanism including a first cleaning assembly to be lowered below a top surface of the first solar panel and above a top surface of the second solar panel;

controlling a rear mechanism including a second cleaning assembly to be raised;

controlling the front mechanism to cause the first cleaning assembly to contact the top surface of the second solar panel;

controlling the propulsion system to drive the robot toward the second solar panel;

controlling the front mechanism to raise the first cleaning assembly such that the propulsion system simultaneously contacts the second solar panel and the first solar panel;

controlling the propulsion system to cause the robot to be exclusively on the second solar panel;

controlling the front mechanism to lower the first cleaning assembly to contact the second solar panel;

controlling the rear mechanism to lower the second cleaning assembly to contact the second solar panel; and

controlling the first and second cleaning assemblies to clean the second solar panel.

43. The computer-implemented method wherein the set of operations are performed based on input received from a computing device communicatively coupled to the robot.

44. The computer-implemented method further comprising performing, by the processing device, a set of operations comprising:

controlling the robot to be oriented at an edge of a first panel facing a second panel, wherein the second panel is discontinuous and separate from the first panel;

controlling a front mechanism including a first cleaning assembly to be raised above the robot;

controlling a rear mechanism including a second cleaning assembly to be raised above the robot;

controlling the propulsion system to drive the robot toward the second solar panel such that the first cleaning assembly is above the second solar panel;

controlling the front mechanism to lower the first cleaning assembly to contact the second solar panel;

controlling the propulsion system to cause the robot to simultaneously be in contact with the first solar panel and the second solar panel;

controlling the rear mechanism to lower the second cleaning assembly to contact the first solar panel such that the propulsion system is not in contact with the first solar panel;

controlling the propulsion system to cause the robot to be exclusively on the second solar panel; and

controlling the first and second cleaning assemblies to clean the second solar panel.

45. The computer-implemented method wherein the set of operations are performed based on input received from a computing device communicatively coupled to the robot.

46. The computer-implemented method further comprising controlling the robot in one or more driving modes comprising manual, driver-aided, driver-confirmed, fully autonomous, or some combination thereof.

47. The computer-implemented method wherein:
manual comprises receiving every command instruction from a computing device operated by a user,
driver-aided comprises generating and executing a first command instruction autonomously, receiving a second command instruction from the computing device of the user, or both, wherein the second command instruction causes the robot to perform a programmed operation,
driver-confirmed comprises generating a third command instruction autonomously and presenting the third command instruction on the robot or on the computing device of the user, and the user can approve or deny the third command instruction using the computing device, and
fully autonomous comprises the control system or a server generating every command instruction.

48. The computer-implemented method further comprising:
receiving, via the processing device, a selection of a switch associated with a driving direction of the robot; and
in response to the selection of the switch, changing a direction of driving and steering of the robot.

49. The computer-implemented method wherein the operating parameter is associated with the propulsion system, the cleaning assembly, the water distribution system, the electromechanical arm, or some combination thereof.

50. The computer-implemented method further comprising:

receiving, via the processing device, sensor data from one or more sensors; and

transmitting, via a network, the sensor data to a remote computing device configured to perform data analytics for a plurality of robots comprising at least the robot based on a plurality of sensor data comprising at least the sensor data, wherein:

the network comprises a near field communication network, a local area network, a wide area network, or some combination thereof.

51. The computer-implemented method wherein:
the operating parameter is associated with the water distribution system,
the operating parameter specifies supplying or retracting a hose relative to the robot to avoid slack or excess tension in the hose while the robot is cleaning the solar panels, and
the hose is wound on a reel mounted to the robot.

52. The computer-implemented method further comprising controlling an aerial vehicle, wherein the aerial vehicle is configured to lift a hose off of a surface of the solar panels as the robot cleans the solar panels, and the aerial vehicle attaches to a supply hose extending to a water supply.

53. A system comprising:

a plurality of cleaning robots;

a single vehicle;

a processing device configured to execute computer instructions to:

cause a first cleaning robot to be placed on a first set of solar panels to clean the first set of solar panels;

cause a second cleaning robot to be placed on a second set of solar panels to simultaneously clean the second set of solar panels while the first cleaning robot cleans the first set of solar panels; and

responsive to an indication the first cleaning robot has cleaned the first set of solar panels, cause the first cleaning robot to be moved to a third set of solar panels to simultaneously clean the third set of solar panels while the second cleaning robot cleans the second set of solar panels.

54. The system wherein the single vehicle comprises an all-terrain vehicle comprises a system for placing the cleaning robots onto and off sets of solar panels, wherein the elevation system comprises a hoist, a fixed platform, or a movable platform.

55. The system wherein the computer instructions are executed based on a signal from a computing device operated by a user of the single vehicle or based on a signal from a remote computing device.

56. The system wherein the processing device is further configured to execute the computer instructions to cause a first water tank of the first cleaning robot to be filled.

57. The system wherein each of the plurality of cleaning robots are autonomous or semi-autonomous.

Embodiments disclosed in this document and the accompanying drawings offer other solutions. For example, versions of the solar panel cleaning system are not supported by railing and do not stay at the site of the solar array. Rather, embodiments can be self-contained, remotely-operated rovers that are portable to be used at different solar panel array sites.

As used herein, the term “overspray” can mean cleaning liquid that becomes airborne from the movement of the brush assembly and causes moisture to spray in various directions away from the brush assembly.

The term “solar array” can include a line or collection of solar panels, not necessarily contiguous but close enough together for an object to move above and across them in a generally linear fashion. Each solar array can be inclined with an upper elevation side and a lower declination side in the width direction of the solar array or row.

As depicted in the drawings, embodiments can include a freely-moving (e.g., autonomous or semi-autonomous operation, with or without human intervention), independent (e.g., each unit can operate separately from or in unison with other units, including swarm capabilities) solar panel cleaning system, method and apparatus. The system can clean one or more arrays of solar panels. Versions can be coupled to and uncoupled from any fixed rails or frame. Examples of the system can traverse and clean from array to array, with or without physical human intervention, and individual robots can communicate with each other for efficiency and to limit redundancy. Embodiments can use a water-based liquid solution to clean solar panels. Some examples include a modular design for ease of assembly, disassembly and transportation between cleaning sites. When fully assembled, versions can be transported from solar array to solar array, with or without handles. Other examples can include optical recognition or inspection of panels during and after cleaning to confirm desired levels of cleanliness.

Versions can include mechanical and electrical assemblies that operate on top of solar panels. The units can actuate forward and backwards on either tracks or wheels, for example. Embodiments can be remotely-controlled, such as by a radio transmitter and receiver, to move in any useful direction.

In some embodiments, at least one rotatable or side-to-side cleaning device can be used. The cleaning device can include one or more of the following: fins or brushes that induce friction, other mechanical stimuli, electric heating, magnetic coupling or combinations thereof. These options can enhance removal of debris from the solar panels.

Other versions can include a powered device, such as a motor, to maneuver the robot around the solar array. Examples can include skid-steer of a drive track, traction, rack-and-pinion, bounce, suction, or any other method of independent powered traversing equipment.

Still other examples of the cleaning devices can be readily maneuvered. For example, they can be lifted, lowered, and moved side-to-side with an actuator to create more downward force to induce more friction for improved cleaning. Optionally, they can be raised and lowered during traverse from one solar array to the next for improved maneuverability over gaps and altitude changes between solar arrays. For example, the lifting and lowering equipment can take the form of a brush, flipper or track. At the end of a solar panel array, the robot can move parallel, diagonally, orthogonally or combinations thereof to traverse to another row of solar panel, in some versions. Embodiments can include slide mechanisms to slide down the panel at an angle of declination relative to the solar panel itself. Such examples can use a relatively low-friction material slider, roller assembly (powered or free rolling), track or combination thereof.

Embodiments can include position compliance. For example, a spring or other electrical or mechanical force can induce downward pressure on the cleaning apparatus, pulling and/or pushing. Position compliance can help ensure that the cleaning assembly (e.g., brushes) stays in contact with the solar panels even if their surfaces are not flat. In contrast, conventional, rigidly-mounted brushes can slightly lift off of the solar panels if the solar panels are not perfectly flat. Thus, providing some compliance with the brush mount allows for constant contact with the solar panels, essentially regardless of the orientation of the body of the robot.

Some examples include a method to steer the assembly in a linear path. Versions can include a system to ensure lateral alignment on solar panels for an automated straight-driving motion. Embodiments include the use of one or more mechanical outriggers, and/or closed-loop control of the drive motors using an edge sensor. These solutions can enable straight tracking with lateral alignment along a panel.

In some versions, the mechanical outrigger can latch and roll on the upper elevation side of the solar panel to guide the robot mechanically. The outrigger can be rigidly or flexibly attached to the robot, in some embodiments. A fixed outrigger can be folded up at the end of each row. The lower declination side outrigger can be folded down as the robot drives back in the reverse direction. Each outrigger, one on each lateral side of the assembly, can be controlled by an actuator.

For embodiments of the electromechanical controls, a closed loop, vision-controlled system can use a camera or other sensing device to detect edges. The electromechanical controls can also take the form of a radio-receiver combination for executing commands from a remote user. Alternatively, examples can activate at a push of a button to cause the assembly to turn (e.g., 90 degrees) or induce a self-driving transition from array to array. This can be done smoothly and automatically as well.

Other examples can include an enclosure or cover to prevent overspray, which can potentially dirty the row of solar panels that have just been cleaned. The enclosures or covers can be provided above, around, or near the cleaning equipment (e.g., brush) to prevent overspray in almost any direction. The covers may be formed from a variety of materials, such as plastic, rubber, fixed bristle, or any suitable material elements that prevent overspray.

Additional versions can prevent the cleaning fluid conduit (e.g., water hose) from getting caught or snagging on solar panel features, or from interfering with movement of the system. For example, a lifting system can increase the effective diameter of the hose without increasing the weight of the hose. Embodiments of the lifting system can include balls, foam noodles, plastic air pillows and/or dunnage. Other examples include use of an airborne vehicle to lift the hose. These can include an electrically-powered, aerial vehicle, such as a flying quadrotor and/or a lighter-than-air balloon, for transporting the hose, such as adjacent to the robot.

In another example, a reel for deployment of the hose can be included. The reel can be located anywhere between the water source and the robotic system. The reel can prevent the hose from snagging as the hose is deployed down a row. The reel also can retrieve the hose, or into the system, on the next row as the system returns.

The terminology used herein is for the purpose of describing particular examples only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drive (SSD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any subcombination. Further, references to values stated in ranges include each and every value within that range.

1. A robot for cleaning solar panels, the robot comprising:
a frame having a longitudinal axis;
a propulsion system coupled to the frame for moving the robot on solar panels;
an arm movably coupled to the frame;
a cleaning assembly coupled to the arm for cleaning the solar panels, the arm and cleaning assembly also are configured to facilitate the transportation of the robot between solar panels that are discontinuous and spaced apart from each other;
a water distribution system coupled to the robot for distributing water during cleaning operations; and
a control system coupled to the robot for operating the robot and controlling the propulsion system, arm, cleaning assembly and water distribution system.

2. The robot of claim 1, wherein the cleaning assembly comprises two cleaning assemblies that are located on opposite longitudinal ends of the frame.

3. The robot of claim 1, wherein a downward force applied by the cleaning assembly to a solar panel is adjustable.

4. The robot of claim 1, wherein the arm comprises a slide configured to facilitate sliding motion of the robot when traversing between solar panels that are discontinuous and spaced apart from each other.

5. The robot of claim 1, wherein the cleaning assembly comprises distal wheels that are rotatable and configured to facilitate movement of the robot when traversing between solar panels that are discontinuous and spaced apart from each other.

6. The robot of claim 1, wherein the water distribution system comprises a water tank mounted to the robot.

7. The robot of claim 1, wherein the water distribution system comprises a reel mounted to the robot, a hose wound on the reel that extends to the robot on one end and to a water source on an opposite end.

8. The robot of claim 7, further comprising a hose control system for applying force to the hose to supply and retract the hose relative to the robot to avoid slack in the hose while the robot is cleaning the solar panels.

9. The robot of claim 1, wherein the water distribution system comprises an aerial vehicle.

10. The robot of claim 9, where the aerial vehicle comprises a supply hose extending to both a water source and the robot.

11. A computer-implemented method for using a control system of a robot to control the robot to clean solar panels, wherein the method comprises:
receiving, at a processing device of the control system, a command instruction, wherein the command instruction is associated with changing an operating parameter of a portion of the robot, wherein the portion comprises a propulsion system, a cleaning assembly, a water distribution system, an electromechanical arm, or some combination thereof;
determining, based on the command instruction, one or more actions to perform to change the operating parameter; and
controlling, via the processing device, the robot to perform the one or more actions to change the operating parameter of the portion of the robot.

12. The computer-implemented method of claim 11, wherein the operating parameter is associated with a saved parameter of a brush included in the cleaning assembly.

13. The computer-implemented method of claim 12, wherein the saved parameter is associated with a raised position, an extended cleaning position, ora lowered position of the brush.

14. The computer-implemented method of claim 11, wherein the operating parameter is associated with a saved parameter of the propulsion system.

15. The computer-implemented method of claim 14, wherein the saved parameter is associated with a speed of a motor of the propulsion system, a rotational direction of the motor, or some combination thereof.

16. The computer-implemented method of claim 11, further comprising:
receiving, from one or more sensors of the robot, sensor data; and
generating the command instruction based on the sensor data.

17. The computer-implemented method of claim 16, further comprising generating, by the processing device, the command instruction in real-time or near real-time.

18. The computer-implemented method of claim 16, wherein the sensor data is associated with a characteristic of the solar panels, a characteristic of the robot, a characteristic of an environment in which the robot is located, a characteristic of another robot, or some combination thereof.

19. The computer-implemented method of claim 18, wherein:
the characteristic of the solar panels pertains to a level of cleanliness of the solar panels achieved by the robot, a temperature of the solar panels, a defect of the solar panels, or some combination thereof,
the characteristic of the robot pertains to a first temperature, a first speed, a first efficiency, a first elapsed time of operation, a first battery level, a first vibration, a first water level, or some combination thereof,
the characteristic of the environment in which the robot is located pertains to a weather condition of the environment,
the characteristic of the another robot pertains to a second temperature, a second speed, a second efficiency, a second elapsed time of operation, a second battery level, a second vibration, a second water level, or some combination thereof.

20. The computer-implemented method of claim 16, wherein the sensor data comprises information pertaining to a location or position of the robot on a solar panel, and the method further comprises:
based on the location or position of the robot on the solar panel, performing the command instruction to cause the robot to turn a certain number of degrees at the location or the position, or to move the cleaning assembly to a desired position.

21. The computer-implemented method of claim 20, wherein the set of operations are performed based on input received from a computing device communicatively coupled to the robot.

22. The computer-implemented method of claim 21, wherein the set of operations are performed based on input received from a computing device communicatively coupled to the robot.
